(19) United States
(12) Patent Application Publication
(10) Pub. No.: US 2025/0303763 A1
(43) Pub. Date: Oct. 2, 2025

(54) IMAGE FORMING APPARATUS

(71) Applicant: CANON KABUSHIKI KAISHA, Tokyo (JP)

(72) Inventors: AYUMU IWANAGA, Chiba (JP); TOMOHARU KITAJIMA, Ibaraki (JP); JUNICHI MOTEKI, Chiba (JP); SHIMPEI KAKIZAKI, Chiba (JP)

(21) Appl. No.: 19/051,507

(22) Filed: Feb. 12, 2025

(30) Foreign Application Priority Data
Mar. 28, 2024 (JP) 2024-053546

(51) Int. Cl. B41J 29/02; B41J 3/54

(52) U.S. Cl. CPC B41J 29/02; B41J 3/543

(57) ABSTRACT

Disclosed is an image forming apparatus including a unit detachable from a frame body. The frame body has first and second pillars distanced from each other in a second direction. When the unit moves, a lower end of a passing portion of the unit passing a position of the second pillar passes at a first height, and an upper end of the passing portion passes at a second height. The second pillar includes a lower and an upper pillar portions. An upper end of the lower pillar portion of the second pillar is at a third height lower than the first height. A lower end of the upper pillar portion of the second pillar is at a fourth height higher than the second height. The first pillar includes a continuous portion between the first and the second heights.

### BACKGROUND OF THE INVENTION

### Field of the Invention

This invention relates to an image forming apparatus wherein a unit thereof is configured to be detached.

### Description of the Related Art

In the field of the industrial printing, image forming apparatuses such as an ink jet printer for large-sized recording materials with various types of units are provided. The unit are provided on the frame body which forms the skeleton of the image forming apparatus and can be drawn, for example, from the front side of the image forming apparatus.

However, the space for proving units in the frame body is limited to a certain range according to the functions of the respective units. Therefore, when the units are disposed on the back side of the pillar of the frame body, the units interfere with the pillar of the frame body, so that the maintenance becomes difficult.

It is possible to enlarge the size of the frame body for increasing the space for providing the units in order to realize the relationship of the arrangement in response to the functions of the units. However, this may lead to a larger size of the image forming apparatus.

### SUMMARY OF THE INVENTION

A representative configuration of the present invention is an image forming apparatus comprising:
a frame body,
a unit supported by the frame body, the unit being configured to be detached from the frame body by moving the unit along a first direction crossing a vertical direction,
wherein the frame body includes a first pillar and a second pillar which extend in the vertical direction respectively and are spaced apart from each other in a second direction crossing the first direction and the vertical direction,
wherein, when the unit moves along the first direction, a passing portion of the unit passes through a position of the second pillar,
wherein, a lower end of the passing portion when passing the position of the second pillar passes at a first height in the vertical direction, and an upper end of the passing portion when passing the position of the second pillar passes at a second height in the vertical direction,
wherein the second pillar includes a lower pillar portion and an upper pillar portion disposed with a distance in the vertical direction,
wherein an upper end of the lower pillar portion of the second pillar is located at a third height in the vertical direction that is lower than the first height,
wherein a lower end of the upper pillar portion of the second pillar is located at a fourth height in the vertical direction that is higher than the second height, and
wherein the first pillar includes a continuous portion that is continuous at least in a region between the first height and the second height in the vertical direction.

Further features of the present invention will become apparent from the following description of exemplary embodiments with reference to the attached drawings.

### BRIEF DESCRIPTION OF THE DRAWINGS

FIG. 1 is a schematic diagram showing a cross-sectional view of an image forming apparatus.

FIG. 2 is a schematic diagram showing a cross-sectional view of a print belt unit of the image forming apparatus.

FIG. 3 is a diagram showing a cross-sectional view of a frame body of the image forming apparatus.

FIG. 4 is a diagram showing a front view of the frame body.

FIG. 5 is a diagram showing a cross-sectional view of a lower frame body of the frame body.

FIGS. 6A and 6B are diagrams showing a cross-sectional view of a bottom plate of the lower frame body of the frame body.

FIGS. 7A, 7B and 7C are schematic diagrams showing a cross-sectional view of a connecting plate attached to the first pillar of the upper frame and the lower frame bodies.

FIGS. 8A and 8B are diagrams for describing the assembling procedure of the lower frame body.

FIG. 9 is a diagram for describing the assembling procedure of the lower frame body.

FIG. 10 is a diagram showing a cross-sectional view of a lower frame body of the frame body.

FIGS. 11A and 11B are schematic diagrams showing cross-sectional views of an image forming portion of a print module.

FIGS. 12A, 12B and 12C are diagrams for describing the assembly procedure of the attaching and detaching member.

FIG. 13 is a diagrams showing a perspective view of an attaching portion of a connecting metal plate.

### DESCRIPTION OF THE EMBODIMENTS

Hereinafter, with reference to the drawings, a preferred embodiment of the present invention will be specifically described in detail. However, the present invention is not limited only to the dimensions, materials, and relative positions of the components of the image forming apparatus described in the following embodiments as long as not being otherwise specified. Further, the components to which the same reference characters are attached have the same configuration or the same effect with each other and duplicate description is omitted as appropriate.

### <Image Forming Apparatus>

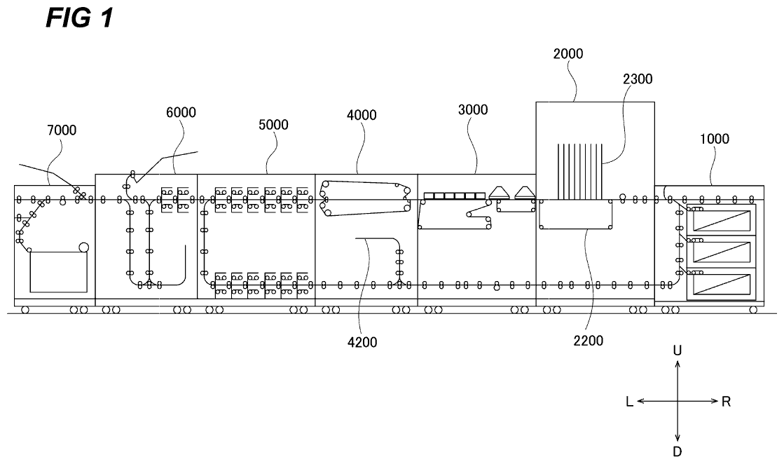

The image forming apparatus according to an embodiment of the present invention will be described with reference to FIG. 1. FIG. 1 is a schematic diagram showing the configuration of the image forming apparatus. The image forming apparatus shown in FIG. 1 is an example of an ink jet type image forming apparatus using ink jet printing system.

In the image forming apparatus, the sheet (recording material) provided from the sheet supplying module 1000 is processed at the print module 2000, the drying module 3000, the fixing module 4000, the cooling module 5000, the reversing module 6000 and the discharging and stacking module 7000 in this order. At the print module 2000, an image is formed on the sheet supplied by the sheet supplying module 1000. The drying module 3000 fixes the ink onto the sheet by reducing the liquid component of the ink. The fixing module 4000 heats the sheet to soften the fixed ink. The cooling module 5000 cools the sheet to harden the ink that has been softened and to suppress a change in temperature of the sheet in the downstream side of the cooling module. The reversing module 6000 changes the direction of the sheet to a desired direction. The discharging and stacking module 7000 stacks the printed sheets in the aligned state.

When the duplex printing should be performed, the sheet is turned over to the print module at the cooling module 5000, the sheet is reversed by the reversing device 4200 provided at the fixing module 4000, so that the positions of the the front surface and back surface as well as the front end and back end of the sheet are exchanged. After that, the sheet travels through the duplex conveying path of the drying module 3000 and the sheet supplying module 1000, and is conveyed again to the print module 2000 where the print procedure for the back surface is performed.

### <Print Module>

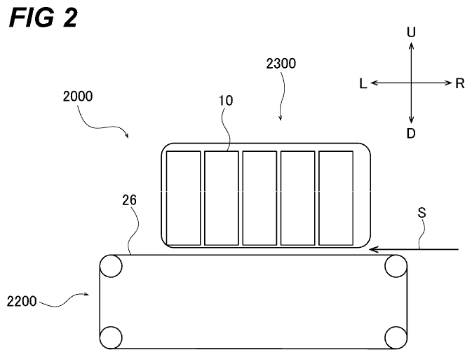

The configuration of the print module 2000 will be described with reference to FIG. 2. FIG. 2 is a schematic diagram showing a cross-sectional view of the print module 2000.

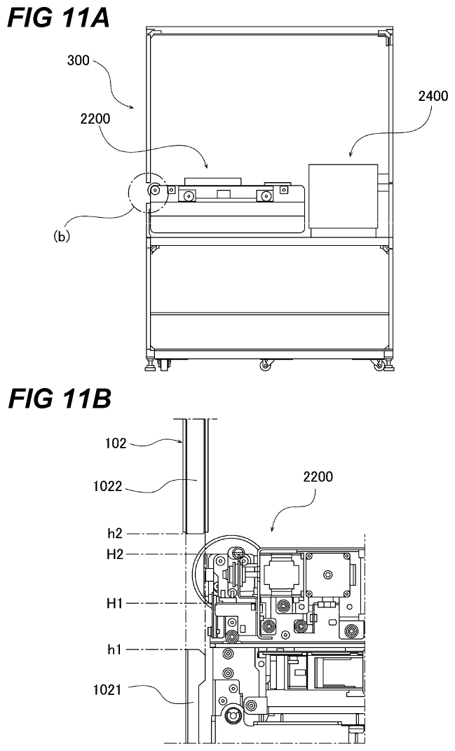

The print module 2000 is an image forming portion that forms an image on the sheet by performing the recording process on the conveyed sheet (recording medium) from the above using recording head 10. The print module 2000 includes the pre-imaging registration correction portion 2400 (see FIG. 11A), the print belt unit 2200, the recording portion 2300. The sheet S is sucked and conveyed by the print belt unit 2200, so that a certain clearance between the sheet and the recording head 10 is maintained.

The inclination and the position of the sheet conveyed from the sheet feeding module 1000 are corrected by the pre-imaging registration correction portion 2400 (see FIG. 11A) and the sheet is further conveyed to the print belt unit 2200. The recording portion 2300 is disposed in the position opposed to the print belt unit 2200 with respect to the conveying path. The recording portion 2300 forms an image on the sheet by performing the recording procedure (print) on the conveyed sheet S from the above using the recording head 10. The print belt unit 2200 is provided that sucks and conveys the sheet in the recording portion 2300 so that the behavior of the conveyed sheet becomes stable immediately under the recording head 10. The sheet S is conveyed on the sheet conveying surface 26 in the print belt unit 2200 with a certain clearance with the recording head 10. The recording head 10 discharge ink at the ink discharging timing to the conveyed sheet to form an image. Multiple recording heads are aligned along the sheet conveying direction in the recording head 10. Five line type recording heads are provided for Y (Yellow), M (Magenta), C (Cyan), Bk (black) and the reaction liquid.

Note that the number of recording heads in the image forming apparatus is not limited to five. As the ink jet system, the system using heating elements, the system using piezo elements, the system using static electric elements and the system using MEMS (Micro Electro Mechanical Systems) elements can be adopted.

In the present embodiment, the front and back direction can be referred to as the first direction. Further, in the present embodiment, the right and left direction is the sheet conveying direction during the image forming. The sheet conveying direction (the right and left direction) can be referred to as the second direction. The upstream side and downstream side of the in the conveying direction of the sheet S passing through the recording portion 2300 are respectively referred to as the right side and left side. In the present embodiment, the second direction is left and right direction and the second direction is the direction crossing the vertical direction. The vertical direction is the direction identical to the upper and lower direction of the image forming apparatus. The upper direction in the vertical direction and the lower direction in the vertical direction are respectively defined as the upper direction and the lower direction. The direction in which the recording portion 2300 is drawn out from the print module 2000 is defined as forward direction and the direction in which the recording portion 2300 is attached to the print module 2000 is defined as backward direction. The forward and backward direction is the first direction to and from the print module 2000. The forward and backward direction is the second direction crossing the upper and lower direction (vertical direction) and left and right direction (second direction). The defined forward direction F, the backward direction B, the rightward direction R, the leftward direction L, the upward direction U and the downward direction D are shown in FIG. 1 and so on.

### <Configuration of Frame Body>

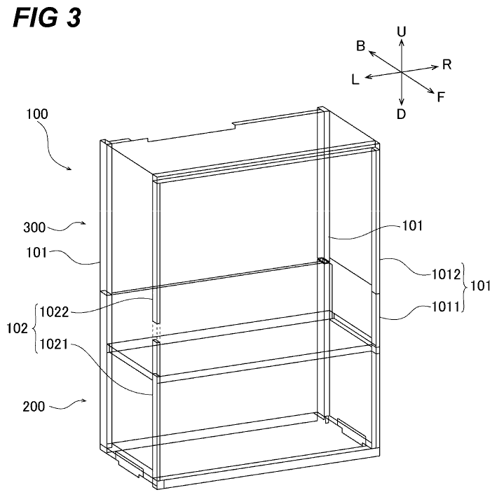

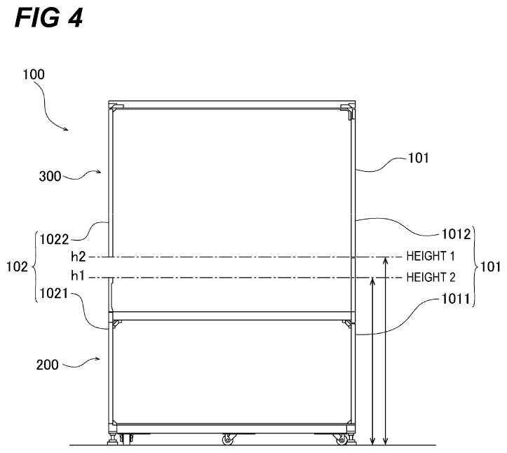

Next, the frame body serving as the skeleton of the image forming apparatus will be described with reference to FIGS. 3 and 4. In the following, the frame body of the print module will be exemplarily described. FIG. 3 is a diagram showing a perspective view of the frame body of the print module. FIG. 4 is a diagram showing a front view of the frame body of the print module.

The print module 2000 is provided with the frame body 100 that supports the units including the pre-imaging registration correction portion 2400, the recording portion 2300 and the print belt unit 2200.

As the units supported by the frame body 100, the pre-imaging registration correction portion 2400, the recording portion 2300 and the print belt unit 2200 are exemplified. The print belt unit 2200 is the first conveying portion that conveys a sheet. The print belt unit 2200 is disposed such that the print belt unit 2200 is opposed to the recording portion 2300 below the recording portion 2300 in the vertical direction. The recording portion 2300 forms an image by discharging ink on a sheet. The pre-imaging registration correction portion 2400 is the second conveying portion that conveys a sheet toward the recording portion 2300. The pre-imaging registration correction portion 2400 is disposed between the print belt unit 2200 and the first-group pillar 101 in the left and right direction.

These units are supported by the frame body 100 such that they can be drawn out from the front side in the forward and backward direction. However, the present invention is not limited to this configuration. For example, the units may be supported by the frame body 100 as to disengage from the frame body 100 in the forward and backward direction. Namly, other configurations can be adopted as long as the units may be supported to be detachably attached to the frame body 100.

The frame body 100 includes the lower frame 200 as a lower frame body, the upper frame 300 as an upper frame body on the upper side of the lower frame 200 in the vertical direction. The frame body 100 is made by temporally assembling and welding the lower frame 200 and the upper frame 300 separately and thereafter by putting the pillars of the upper frame 300 on those of the lower frame 200 to integrate the lower frame 200 with the upper frame 300. Namely, the upper frame 300 is connected to the upper side of the lower frame 200 in the vertical direction.

As shown in FIG. 3, the frame body 100 has four pillars including the first-group pillars 101 and the second-group pillar 102 that are distanced with each other in the second direction (left and right direction) crossing the vertical direction and that respectively extend in the vertical direction.

The second pillar 102 (second-group pillar) out of the four pillars is located on the left-front side of the frame body 100 discontinues at the region in the vertical direction where the print belt unit 2200 is attached and detached. Namely, as shown in FIG. 4, the second pillar 102 is disconnected in the region between height 1 and the height 2 from the ground surface (installation surface) in the vertical direction.

The first-group pillars 101 other than the second pillar 102 (second-group pillar) out of the four pillars are not disconnected in the vertical direction. Namely, the first-group pillars 101 are continuous in the region between the height 1 and the height 2. The first-group pillar 101 located on the right-front side of the frame body 100 out of the three first-group pillars 101 is referred to as the first pillar. The configurations of the first-group pillar 101 located on the right-back side of the frame body 100 and the fist-group pillar 101 located on the left-back side of the frame body 100 are the same as that of the the fist-group pillar 101 (first pillar) located on the right-front side of the frame body 100.

The height 1 is defined as a height from the ground surface (installation surface) to the first position h1 (a third height) in the vertical direction. The height 2 is defined as a height from the ground surface (installation surface) to the second position h2 (a fourth height) which is higher than the first position h1 in the vertical direction. In short, the height 1 is less than the height 2.

The frame body 100 supports the recording portion 2300 as a unit between the first pillar (first-group pillar 101) and the second pillar (second-group pillar 102) in the left and right direction, and between the height 1 and height 2 in the vertical direction. The frame body 100 is constituted by the lower frame 200 and the upper frame 300. The configurations of the lower frame 200 and the upper frame 300 will be described later.

The first-group pillar 101 is continuous in the range in which a unit is attached and detached is constituted by the first lower pillar 1011 included in the lower frame 200, which pillar extends upwardly until the second position h2 (a fourth height) and the first upper pillar 1012 included in the upper frame 300, which pillar extends upwardly from the second position h2.

The first-group pillar 102 is disconnected in the range in which a unit is attached and detached is constituted by the second lower pillar 1021 included in the lower frame 200, which pillar extends upwardly until the first position h1 and the first upper pillar 1022 included in the upper frame 300, which pillar extends upwardly from the second position h2.

### <Lower Frame>

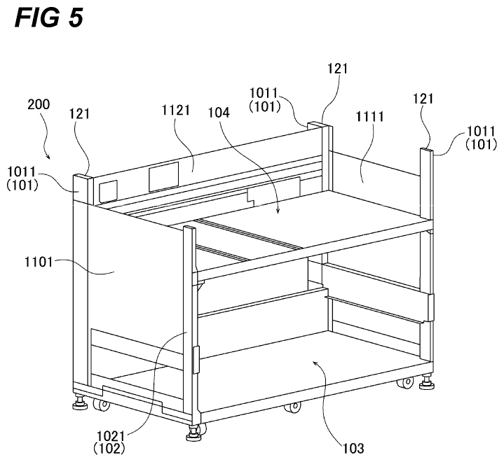

As shown in FIG. 5, the lower frame 200 is configured to be of a shelf-like shape such that the four lower pillars 1011, 1021 stand on the four corners of the bottom plate 103, the lower pillars are connected to each other by the right-side lower plate 1111 and the back side lower plate 1121, and the middle plate 104 is disposed over the bottom plate 103. Further, the lower pillar 1021 on the left-front side and the lower pillar 1011 on the left-back side are connected by the left side lower plate 1101, the lower pillar 1011 on the right-front side and the lower pillar 1011 on the left-back side are connected by the right side lower plate 1111, and the lower pillar 1011 on the right-back side and the lower pillar 1011 on the left-back side are connected by the back side lower plate 1121. In the following, the components of the lower frame 200 will be described.

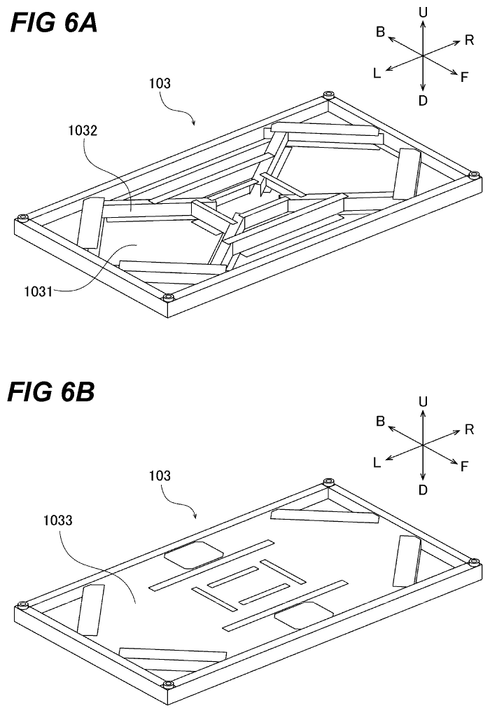

As shown in FIG. 6A, the bottom plate 103 is configured such that the the rim of the plane plate 1031 is bent to become of a box-like shape and the reinforcement beams 1032 are attached in the space formed by the box-like shape by welding the reinforcement beams 1032. Further, as shown in FIG. 6B, the cover 1033 is attached by screws to the bottom plate 103 so as to cover the space formed by the box-like shape, realizing the reinforcement of the bottom plate 103.

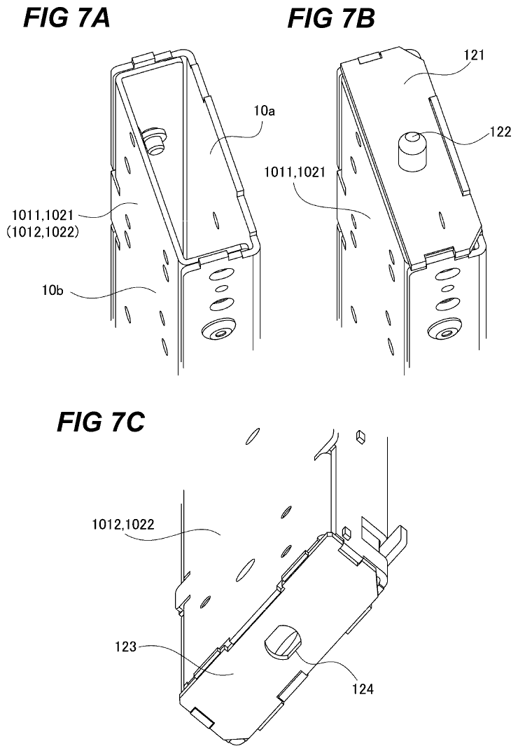

The lower pillar 1011 of the lower frame 200 is configured by the pillars 10a and 10b that have been formed to be bent like a squared U shape in the cross-section as shown in FIG. 7A to be assembled in a square shape in the cross-section. When assembling the pillars 10a and 10b, the positions of the pillars 10a and 10b are provisionally positioned by driving rivets at the appropriate positions, and thereafter the pillars 10a and 10b are welded, so that the lower pillar 1011 of a square shape is acquired with an appropriate strength. The lower pillar 1021 is configured similarly to the lower pillar 1011 except for the length in the vertical direction.

Out of the four lower pillars 1011, 1021 of the lower frame 200, at the apex of each of the first lower pillars 1011 disposed on the right-front side, the right-back side and the left-back side of the apparatus except for the second lower pillar 1021, the lower connection plate 121 is attached as to cover the cross section as shown in FIG. 7B. On the lower connection plate 121, the clamped pin 122 is fixed as to protrude upwardly from the pillar.

The lower pillars 1011, 1021 are connected to the left side lower plate 1101, the right side lower plate 1111, and the back side lower plate 1121 by welding. The back side plate unit in which the back side lower plate 1121 and the two lower pillars 1011 are integrated, the left side plate unit in which the left side lower plate 1101 and the single lower pillar 1021 are integrated, and the right side plate unit in which the right side lower plate 1111 and the single lower pillar 1011 are integrated are configured.

The middle plate 104 is configured similarly to the bottom plate 103 without the cover 1033. Namely, the reinforcement beams are attached by welding inside the box-like shape formed by the plane plate whose rim is bent.

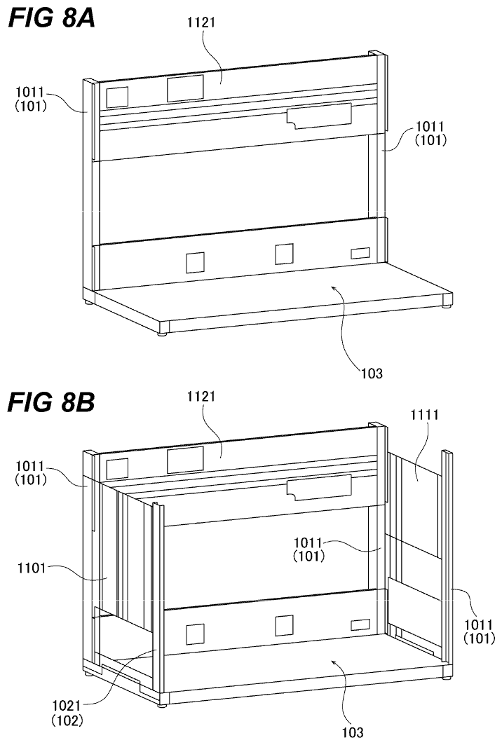

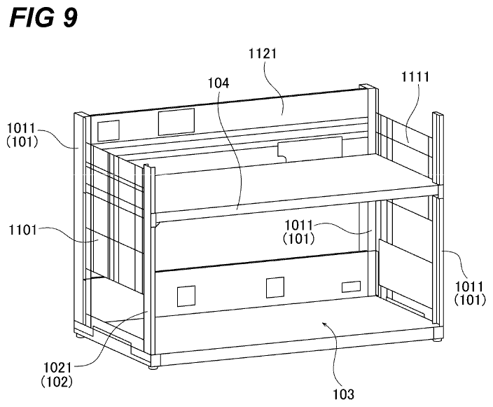

The procedure of assembling the above-described elements for configuring the lower frame 200 will be described with reference to FIGS. 8A, 8B and 9. FIGS. 8A, 8B and 9 are diagrams for describing the assembling procedure of the lower frame.

First, as shown in FIG. 8A, the back side plate unit is put in the state in which the back side plate unit stands on the bottom plate 103 and then the back side plate unit is fixed to the bottom plate 103 with rivets. Thereafter, as shown in FIG. 8B, the left side plate unit and the right side plate unit are put in the state in which the left side plate unit and the right side plate unit stand on the bottom plate 103, and then the left side plate unit and the right side plate unit are connected to the bottom plate 103 with rivets and the left side plate unit and the right side plate unit are connected to the back side plate unit with rivets. As a result, the bottom plate 103, the back side plate unit, the left side plate unit, and the right side plate unit are connected to each other. Thereafter, as shown in FIG. 9, the first lower pillar 1011 and second lower pillar 1021 standing on bottom plate 103 are connected with screws to form the lower frame 200. Thereafter, the bottom plate 103, the back side plate unit, the left side plate unit, and the right side plate unit, which have been connected to each other with rivets are fixed to each other by welding in appropriate positions.

### <Upper Frame>

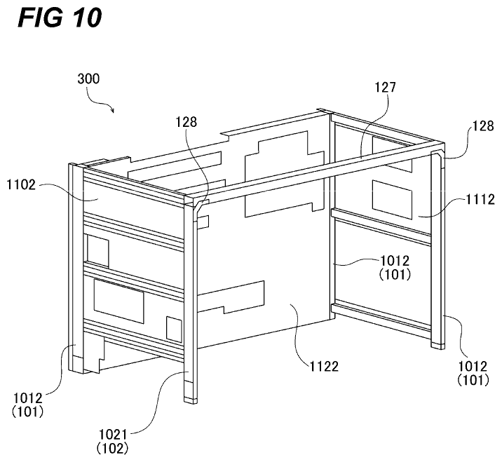

As shown in FIG. 10, the upper frame 300 has the configuration in which the left side upper plate 1102, the right side upper plate 1112, and the back side upper plate 1122 are connected to the four upper pillars 1012 and 1022. Specifically, the left side upper plate 1102 is attached to the upper pillar 1022 on the left-front side and the upper pillar 1012 on the left-back side, the right side upper plate 1112 is attached to the upper pillar 1012 on the right-front side and the upper pillar 1012 on the right-back side, and the back side upper plate 1122 is attached to the the upper pillar 1012 on the right-back side and the upper pillar 1012 on the left-back side. In the following, the upper frame 300 will be described.

The four upper pillars 1012 and 1022 of the upper frame 300 are configured by combining the pillars 10a and 10b with a squared-U shape to become of a square shape similarly to the lower pillar 1011 of the lower frame 200 (See FIG. 7A).

Out of the four upper pillars 1012, 1022 of the upper frame 300, at the lower end portion of each of the first upper pillars 1012 disposed on the right-front side, the right-back side and the left-back side of the apparatus except for the second upper pillar 1022, the upper connection plate 123 is attached as to cover the cross section as shown in FIG. 7C. On the upper connection plate 123, the hole 124 to be fitted to the the pin 122 attached to the lower connection plate 121 of the lower frame 200 is provided.

The upper pillars 1012, 1022 are connected to the left side upper plate 1102, the right side upper plate 1112, and the back side upper plate 1122 by welding. The back side plate unit in which the back side upper plate 1122 and the two upper pillars 1012 are integrated, the left side plate unit in which the left side upper plate 1102 and the single upper pillar 1022 are integrated, and the right side plate unit in which the right side upper plate 1112 and the single lower pillar 1011 are integrated are configured.

Next, the procedure of assembling the above-described elements for configuring the upper frame 300 will be described.

When making the upper frame 300, the left side plate unit and the right side plate unit are fixed to the back side plate unit with rivets similarly to the lower frame 200. As a result, the back side plate unit, the left side plate unit and the right side plate unit are connected to each other. Thereafter, the beam 127 is disposed laterally on the top surfaces of the pillar 1022 of the left side plate unit and the pillar 1012 of the right side plate unit. Further, the beam 127 is fixed to the pillars 1022 and 1012 of the left side plate unit and the right side plate unit with rivets via the connection metal plate 128 having an L-shape. Thereafter, the back side plate unit, the left side plate unit, and the right side plate unit, which have been fixed to each other with rivets are connected and fixed to each other by welding.

<Combining Upper Frame with Lower Frame>

When combining the upper frame with the lower frame, the pin 122 that protrudes from the apex of the pillar of the lower frame 200 is fitted into the hole 124 of the upper connection plate 123 attached to the lower end portion of the pillar of the upper frame 300. Namely, the frame body 100 is configured such that the upper frame 300 is connected to the upper side of the lower frame 200 in the vertical direction.

The bottom plate 103, the pillar with a square shape, the middle plate 104, the left back side plate and the right back side plate do not necessarily have the above described configuration and the shapes as long as they meet the required strengths and functions. Further, the configurations of the side plate unit and the assembling order for the frame body 100 are not limited to the those described above either.

When combining the upper frame with the lower frame, the pins 122 of the lower connection plates 121 of the first lower pillars 1011 disposed on the right-front side, right-back side, and the left-back side of the lower frame 200 are respectively fitted into the holes 124 of the upper connection plates 123 of the first upper pillars 1012 disposed on the right-front side, the right-back side, the left-back side of the upper frame 300, so that the continuous pillars 101 in the vertical direction are configured.

When combining the upper frame with the lower frame, the lower end portion of the second upper pillar 1022 disposed on the left-front aide of the upper frame 300 is opposed to the apexes of the second lower pillar 1021 disposed on the left-front side of the lower frame 200, so that the pillars 102 has the discontinued part for the region between the first position h1 and the second position h2 for attaching and detaching a unit.

### <Disposition of Unit on Frame Body>

The disposition of a unit to be supported by the frame body 100 will be described with reference to FIGS. 11A and 11B. FIGS. 11A and 11B are schematic diagrams showing cross-sectional views of an image forming portion of a print module.

As shown in FIG. 11A, the print belt unit 2200 is installed on the middle plate 104 of the lower frame 200 of the frame body 100. The print belt unit 2200 is movable on a rail laid on the middle plate 104, and can be drawn out from the apparatus towards the forward direction during maintenance.

In addition to the print belt unit 2200, the pre-imaging registration correction portion 2400 is disposed on the middle plate 104. The pre-imaging registration correction portion 2400 is disposed upstream of the print belt unit 2200 in the conveying direction. During printing, the pre-imaging registration portion 2400 receives the sheet S from the sheet supplying module 1000 (See FIG. 1) located upstream of the print module 2000 in the conveying direction, and appropriately corrects the posture of the sheet S to be ready for imaging. Then, the sheet S is passed from the pre-imaging registration portion 2400 on to the print belt unit 2200, where an image is formed.

As shown in FIG. 11A, the region of the middle plate 104 in the left and right direction is occupied by the pre-imaging registration portion 2400 and the print belt unit 2200, which are disposed along the conveying direction. As a result, the print belt unit 2200 is disposed close to the end portion of the print module 2000 downstream in the conveying direction. Taking advantage of this disposition, the print belt unit 2200 has the function of discharging the sheet to the downstream module.

As shown in FIG. 11B, if a part of the print belt unit 2200 is located behind the pillar of the frame body 100 (broken line in the figure) when viewed from the front side of the print module 2000, the print belt unit 2200 interferes with the pillar of the frame body 100 during drawing out the print module 2000 from the apparatus. The print belt unit 2200 and the pre-imaging registration correction portion 2400 could be downsized in order to avoid the interference. However, this could lead to the reduction of the functions of the print belt unit 2200 and the pre-imaging registration correction portion 2400, so that the product performance may get worsen. Further, the print belt unit 2200 would be away from the end portion of the print module 2000 for the width of the pillar, so that it might be difficult to pass on the sheet to the downstream module.

Therefore, the second-group pillar 102 of the frame body 100 is configured to be discontinued in the region between the first position h1 and the second position h2. Namely, the second-group pillar 102 has the second lower pillar 1021 (lower pillar portion) and the second upper pillar 1022 (upper pillar portion) as two separated portions. The second lower pillar 1021 extends upwardly to the first position h1 in the vertical direction. In other words, the upper end of the second lower pillar 1021 is located in the first position h1. The second upper pillar 1022 extends upwardly from the second position h2. In other words, the lower end of the second upper pillar 1022 is located in the second position h2. The relationship between the first position h1, the second position h2, and the part of the print belt unit 2200 that passes through the position of the second-group pillar 102 will be described when the print belt unit 2200 is attached and detached. As shown in FIG. 11B, when the print belt unit 2200 moves along the first direction and the part of the print belt unit 2200 passes though the position of the second-group pillar, the lower end of the part passes through the first height H1. Further, when the print belt unit 2200 moves along the first direction and the part of the print belt unit 2200 passes though the position of the second-group pillar 102, the upper end of the part passes through the second height H2. The first position h1, which is the position of the upper end of the second lower pillar 1021, is lower than the first height H1 in the vertical direction. Further, the second position h2, which is the position of the lower end of the second upper pillar 1022, is higher than the second height H2 in the vertical direction. Therefore, the second-group pillar 102 is configured to have a disconnected part in the region through which the print belt unit 2200 travels when the print belt unit 2200 is attached or detached. As a result, the print belt unit 2200 can be attached or detached without interfering with the pillar 102 of the frame body 100, enabling to keep the maintainability without inviting a larger size of the apparatus. In contrast, the first-group pillars 101 have a part that is continuous at least from the first height H1 and the second height H2 in the vertical direction. Namely, the first-group pillars 101 are continuous in the region corresponding to the disconnected part of the second-group pillar 102. With this configuration, the strength of the frame body can be maintained.

### <Attachable and Detachable Member>

As described above, the rigidness of the frame body 100 is enough owing to the continuity of the first-group pillars 101. However, when an unexpected force is applied, the region of the apparatus higher than the heigh 2 may be tilted since the frame body 100 cannot endure the force due to the partial discontinuity of the second-group pillar 102 of the frame body 100. Therefore, when the print belt unit 2200 is not drawing out from the apparatus, the disconnected part (the part between the first position h1 and the second position h2) is connected to be continuous similarly to the first-group pillar 101 in order to further improve robustness.

In view of the above, the image forming apparatus according to the present embodiment is provided with the attachable and detachable member 125 that is detachably attachable to the second-group pillar 102. When the unit is not drawn out, the attachable and detachable member 125 is attached to the discontinued part of the second-group pillar 102 the present embodiment, the attachable and detachable member 125 is disposed in the region in which the print belt unit 2200 is attached and detached between the second lower pillar 1021 and the second upper pillar 1022 of the second-group pillar 102 to connect the second lower pillar 1021 with the second upper pillar 1022.

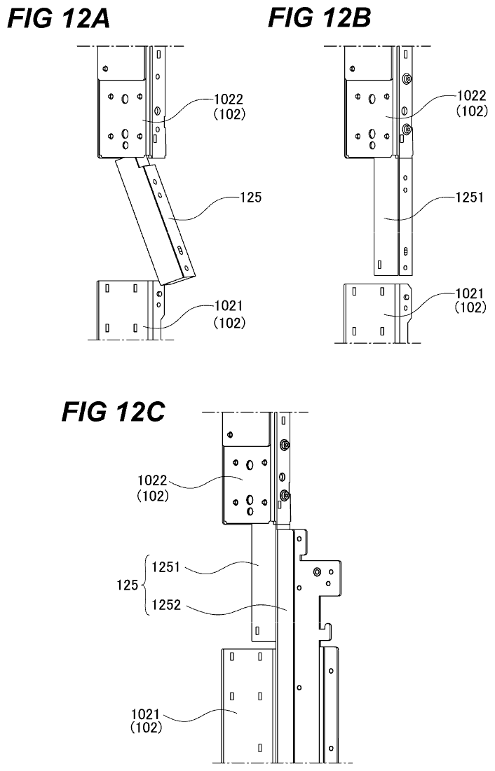

The configuration of the attachable and detachable member 125 and attaching and detaching of the reinforcement block 1251 and the reinforcement metal plate 1252 of the attachable and detachable member 125 will be described with reference to FIGS. 12A to 12C. FIGS. 12A to 12C are explanatory diagrams for describing the assembling procedure of the attachable and detachable member 125.

The attachable and detachable member 125 is constituted by the reinforcement block 1251, which is a first attachable and detachable member and the reinforcement metal plate 1252, which is a second attachable and detachable member. The reinforcement block 1251 is connected to the reinforcement metal plate 1252 and the second upper pillar 1022. The reinforcement metal plate 1252 is connected to the reinforcement block 1251 and the second lower pillar 1021. The connection of these members will be describe in detail below.

First, as shown in FIG. 12A, the upper portion of the reinforcement block 1251 is disposed in the pillar such the upper portion enters the inside of the second pillar 1022 of the upper frame 300. Thereafter, the other portion of the reinforcement block 1251 is drawn in and as shown in FIG. 12B, the reinforcement block 1251 is fixed to the second pillar 1022 by a screw. Thereafter, as shown in FIG. 12C, the reinforcement metal plate 1252 is fixed to the reinforcement block 1251 and the second pillar 1021 of the lower frame 200 by screws. As described above, the disconnected region between the upper frame 300 and the second pillar 102 of the lower frame 200 is filled with the reinforcement block 1251 and the reinforcement metal plate 1252 of the attachable and detachable member 125.

The detachment of the attachable and detachable member 125 can be performed by retracing the above procedure in reverse order.

In the present embodiment, the attachable and detachable member 125 is made up of two components. However, the present invention is not limited to this configuration. For example, the attachable and detachable member 125 may be made up of one component, or three or more components. It is sufficient that the attachable and detachable member 125 be configured to be detachably attached to the second pillar 102 and to fill the disconnected area. Further, the attaching method and procedure of the attachable and detachable member 125 to the second pillar 102 is not limited to the above described examples.

### <Connection Metal Plate>

After the attachable and detachable member 125 is detached from the second pillar 102 during the maintenance, the upper frame 300 may fall down towards the second pillar 1022 due to the weight of the upper frame 300.

In view of this, the image forming apparatus according to the present embodiment is provided with the connection metal plate 126 as the connection member connecting the second lower pillar 1021 and the second upper pillar 1022 outside the region in which the print belt unit 2200 is attached and detached in the left and right direction.

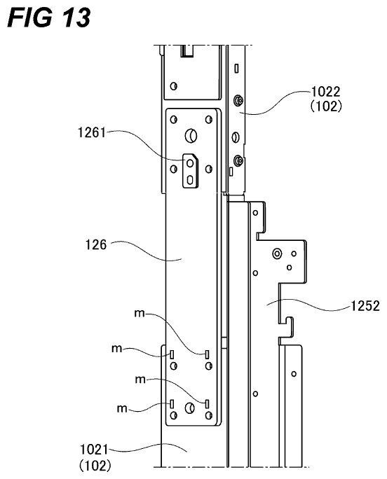

The connection metal plate 126 will be described with reference to FIG. 13. FIG. 13 is a diagram showing a perspective view of the attaching portion of the connection metal plate.

The connection metal plate 126 is attached to the outside surface of each pillar such that the connection metal plate 126 staddles with the second lower pillar 1021 and the second upper pillar 1022 and does not interfere with the print belt unit 2200 when drawing it out. Namly, as shown in FIG. 13, the connecting metal plate 126 as the connecting member connects the second lower pillar 1021 with the second upper pillar 1022 outside the region in which the attaching and detaching member 125 is disposed in the left and right direction. Therefore, even in the state where the attaching and detaching member 126 is attached between the second lower pillar 1021 and the second upper pillar 1022, the attaching and detaching member 126 can connect the second lower pillar 1021 with the second upper pillar 1022.

The connection metal plate 126 is fixed to the second lower pillar 1021 by welding at the welding point m, and is fixed to the second upper pillar 1022 by pin and screw using the small metal plate 1261 with a clamping shaft. The connection metal plate 126 should have such a material and such a plate thickness that the connection metal plate 126 is not buckled by the weight of the upper frame 300. The connection metal plate 126 is attached to the frame body 100, which is a skeleton of the image forming apparatus. Therefore, when a bent portion is formed on the connection metal plate 126, the image forming apparatus becomes larger, leading to the problems such as being unable to put it on an elevator and having larger possibility of getting damaged by being hit during transporting it. Therefore, the connection metal plate 126 should be formed like a plate and the strength is guaranteed only by plate thickness, width and material. However, the configuration is not limited to this when the image forming apparatus is small enough that there is little effect of complexity of the shape.

In the present embodiment, the connection metal plate 126 is connected to the second pillar 102 by pin, screw and welding. These fastening methods are used in view of required component precision and cost. However, the fastening method is not generally limited to these ones.

Next, the calculation used for deciding the shape of the connection metal plate 126 to prevent it from being buckled.

The load the connection metal plate 126 receives is about a total of the weight of the upper frame 300, the weight of the exterior, the weight of the attached unit. In the present embodiment, the load is estimated to about 200 kg. The shape and the material of the connection metal plate 126 is decided such that when the load N applied to one pillar is set to 50 kg, the buckling load P is greater than the load N. The following Equation 1 is the one for calculating the buckling load P.

P=n(π²EI)/I² Equation 1

As described above, in the present embodiment, the shape of the connection metal plate 126 is like a plate. Therefore, the geometrical moment of inertia I is calculated by the following Equation 2.

I=(bh³)/12 Equation 2

In Equation 1, the coefficient n is determined by the supporting system of the metal plate. In the present embodiment, the double-supporting system is adopted and n=4.

In the present embodiment, the material of the connection metal plate 126 is SUS with the shape of plate having thickness 5.0 mm, width 50 mm, and length 138.2 mm. As a result, the buckling load P is 207.8 kg. In this case, buckling load P being 207.8 kg is greater than load N being 50 kg, and the safety ratio of about 4.0 is kept. However, this calculation is for load in the static state, and the connection metal plate 126 is not enough for the unexpected impact applied in the transportation and in the starting operation. So, it is required for the attaching and detaching member 125 in a case other than maintenance.

According to the above calculation, by adding the connection metal plate 126 which can endure the load during maintenance, the print belt unit 2200 can be drawn out safely by detaching only the attaching and detaching member 125.

In the present embodiment, the calculation for the connection metal plate 126 has the above result, the shape, the size, and the material of the connection metal plate 126 are different according to the rigidness due to difference in size of the apparatus and the configuration of the frame body. So, the present invention is not limited to the above calculation.

As described above, the print belt unit 2200 can be attached and detached without interfering with the second pillar 102 of the frame body 100, so that maintainability can be kept without inviting a larger size of the apparatus.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-053546 filed Mar. 28, 2024, which is hereby incorporated by reference herein in its entirety.

What is claimed is:

1. An image forming apparatus comprising:
a frame body,
a unit supported by the frame body, the unit being configured to be detached from the frame body by moving the unit along a first direction crossing a vertical direction,
wherein the frame body includes a first pillar and a second pillar which extend in the vertical direction respectively and are spaced apart from each other in a second direction crossing the first direction and the vertical direction,
wherein, when the unit moves along the first direction, a passing portion of the unit passes through a position of the second pillar,
wherein, a lower end of the passing portion when passing the position of the second pillar passes at a first height in the vertical direction, and an upper end of the passing portion when passing the position of the second pillar passes at a second height in the vertical direction,
wherein the second pillar includes a lower pillar portion and an upper pillar portion disposed with a distance in the vertical direction,
wherein an upper end of the lower pillar portion of the second pillar is located at a third height in the vertical direction that is lower than the first height,
wherein a lower end of the upper pillar portion of the second pillar is located at a fourth height in the vertical direction that is higher than the second height, and
wherein the first pillar includes a continuous portion that is continuous at least in a region between the first height and the second height in the vertical direction.

2. The image forming apparatus according to claim 1,
wherein the second pillar includes a detachable member that is disposed in a region through which the passing portion of the unit passes when the unit moves along the first direction and is connected to the lower pillar portion and to the upper pillar portion,
wherein the detachable member is configured to be detachable from the upper pillar portion and the lower pillar portion.

3. The image forming apparatus according to claim 2,
wherein the detachable member includes a first detachable member and a second detachable member,
wherein the first detachable member is connected to the second detachable member and the upper pillar portion, and
wherein the second detachable member is connected to the first detachable member and the lower pillar portion.

4. The image forming apparatus according to claim 1,
wherein the second pillar includes a connection member that connects the upper pillar portion and the lower pillar portion, and
wherein the connection member is disposed outside a region through which the passing portion of the unit passes when the unit moves along the first direction.

5. The image forming apparatus according to claim 2,
wherein the second pillar includes a connection member that connects the upper pillar portion and the lower pillar portion, and
wherein the connection member is disposed outside the region through which the passing portion of the unit passes when the unit moves along the first direction.

6. The image forming apparatus according to claim 5,
wherein the detachable member includes a bented metal plate, and
wherein the connection member includes a planer plate.

7. The image forming apparatus according to claim 1,
wherein the unit includes a conveying portion configured to convey a sheet,
wherein the convaying portion is configured to be detached from the frame body by moving along the first direction and includes the passing portion.

8. The image forming apparatus according to claim 1, further comprising:
a first conveying portion configured to convey a sheet;
a recording portion configured to form an image by discharging ink to the sheet; and
a second conveying portion configured to convey the sheet toward the recording portion,
wherein at least one of the first conveying portion, the recording portion and the second conveying portion is configured as a part of the unit, and
wherein the second conveying portion is disposed between the first conveying portion and the first pillar in the second direction and is supported by the frame body.

9. The image forming apparatus according to claim 1,
wherein the image forming apparatus are configured by a plurality of modules including at least a first module and a second module that is located downstream of the first module in a sheet conveying direction and that is connected to the first module,
wherein the first module includes the frame body, and
wherein the image forming apparatus includes a discharge portion as the unit that discharges a sheet in order to convey the sheet to the second module.
